(19) United States
(12) Patent Application Publication
(10) Pub. No.: US 2020/0080793 A1
(43) Pub. Date: Mar. 12, 2020

(54) Method for Making Thermal Management Material and Matrix

(71) Applicant: Martin Houle, Laval (CA)

(72) Inventor: Martin Houle, Laval (CA)

(21) Appl. No.: 16/127,332

(22) Filed: Sep. 11, 2018

(51) Int. Cl. F28D 20/02; H01M 10/615; H01M 10/659

(52) U.S. Cl. CPC F28D 20/023; H01M 10/659; H01M 10/615

(57) ABSTRACT

Described herein is a method to load graphite material with phase change material (PCM) to yield thermal management material. More specifically, graphite flakes are first expanded before being compacted into relatively thin graphite elements. The thin graphite elements are then loaded with PCM. The thermal management matrix may then be formed from the PCM loaded graphite elements to receive cells and form a battery module. The thermal management material help preventing thermal runaway in case of cell failure. Also described herein are methods to electrically insulate the individual cells and the completed battery module. The methods described herein are particularly suited for large volume fabrication of thermal management material and thermal management matrix.

### CROSS REFERENCE TO RELATED PATENT APPLICATION

This application claims the benefit of U.S. Provisional Application No. 62/557,190, filed on Sep. 12, 2107, the content of which is incorporated by reference herein.

### FIELD

The present disclosure relates to thermal management. More specifically, the present disclosure is concerned with a method for making thermal management material and matrix for batteries.

### BACKGROUND

Thermal management of batteries is known. The goal being generally to maintain a temperature of the cells of a battery pack for the optimal used thereof.

For example, U.S. Pat. No. 8,273,474 issued to Al-Hallaj et al. in 2012 describes a battery system thermal management using a thermal management matrix including a supply of phase change material disposed in a heat conductive lattice member that is in contact with the cells of the battery module. Al-Hallaj et al. propose the making of a suitable graphite heat conductive lattice member by compacting expanded graphite to a desired bulk density and to a desired size for the battery module. Paraffin wax phase change material (PCM) is encapsulated in the graphite lattice member by loading PCM via capillary forces between liquid phase change material and the graphite such as by submerging the graphite lattice member in a suitable liquid paraffin bath. It is also taught by Al-Hallaj that the Micro-encapsulation of the PCM within the graphite matrix can be done at or under pressurized, atmospheric or vacuum conditions. Such a thermal management matrix can be drilled or otherwise be provided with holes or cavities of desired dimensions formed therein to allow the insertion of, or to otherwise accept, a desired electrochemical cell element.

A drawback of this technique for making a thermal management matrix is the length of time required for the liquid phase PCM to completely saturate the compacted expanded graphite forming the heat conducting lattice member.

### BRIEF DESCRIPTION OF THE DRAWINGS

In the appended drawings:

FIG. 1 is a bloc diagram of an illustrated embodiment of a method for making a thermal management matrix;

FIG. 2 is a perspective view of a thermal management matrix according to an illustrative embodiment;

FIGS. 3A to 3D are perspective views illustrating the assembly of a battery module including a thermal management matrix;

FIG. 4 is a perspective view of a thin electrically insulating material sheet used to wrap a thermal management matrix according to a first illustrative embodiment; and

FIG. 5 is a perspective view of a matrix wrapping assembly according to a second illustrative embodiment.

### DETAILED DESCRIPTION

In accordance with an illustrative embodiment, there is provided a method of making thermal management material including: compacting expanded graphite flakes into thin elements; and loading the thin elements with PCM (phase change material).

In accordance with another aspect, there is provided a method comprising: compacting expanded graphite flakes into thin elements; loading the thin elements with PCM, resulting in PCM loaded graphite; breaking up the PCM loaded graphite into small pieces; and forming a matrix from the small pieces of PCM loaded graphite.

According to another aspect, there is provided a * A method to assemble a battery module including: providing a thermal management matrix provided with at least two cell receiving cavities and an outside surface; inserting a respective cell into each of the at least two cell receiving cavities; interconnecting the cells; and electrically insulating the outside surface.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification and in the appended claims, various terminology which is directional, geometrical and/or spatial in nature such as “longitudinal”, “horizontal”, “front”, rear”, “upwardly”, “downwardly”, etc. is used. It is to be understood that such terminology is used for ease of description and in a relative sense only and is not to be taken in any way as a limitation upon the scope of the present disclosure.

The expression “connected” should be construed herein and in the appended claims broadly so as to include any cooperative or passive association between mechanical parts or components. For example, such parts may be assembled together by direct coupling, or indirectly coupled using further parts. The coupling can also be remote, using for example a magnetic field or else.

It is to be noted that the expression “cell” is to be construed herein and in the appended claims as any cell element that is suitable to form a battery module, including electrochemical cells. As non-limiting examples, Lithium-ion, Lithium-ion polymer, Ni-Cad cells, capacitors and supercapacitors are considered cells herein.

Other objects, advantages and features of the method for making thermal management material and matrix will become more apparent upon reading of the following non-restrictive description of illustrative embodiments thereof, given by way of example only with reference to the accompanying drawings.

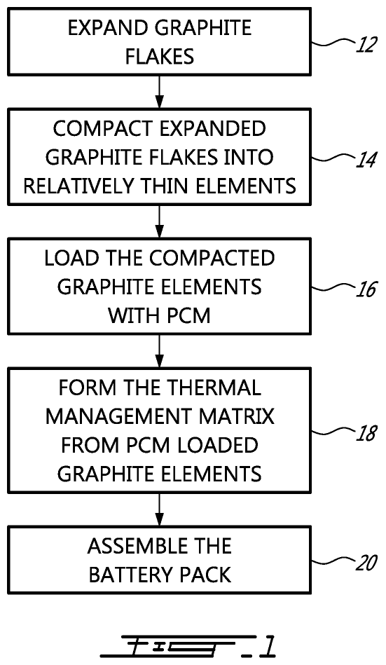

Referring to FIG. 1 of the appended drawings, the steps of making a battery module including a thermal management matrix will be described hereinbelow.

Generally stated, graphite flakes are first expanded in step 12 before being compacted into relatively thin expanded graphite elements in step 14. In step 16, the graphite elements are loaded with PCM. The thermal management matrix may then be formed from the PCM loaded graphite elements in step 18. Finally, the battery module is assembled in step 20.

Each of these steps will now be described in more detail.

Graphite Flake Expansion

It is believed that the expansion of graphite flakes is well known in the art. As a non-limiting example, expanded graphite may be produced from flake graphite such as by soaking the flake graphite in a bath of sulfuric and nitric acid and then appropriately heat-treating the soaked material. Of course, other techniques could be used.

Compaction of the Expanded Graphite

Many methods are available to compact the expanded graphite into relatively thin graphite elements in step 14.

As a non-limiting example, a machine similar to a pill-making machine can be used to make thin elements that are pill-size graphite elements, which are both thin and small.

Another example would be to compress the expanded graphite into continuous thin sheets that may optionally be cut into strips or into pieces before or after the PCM loading step.

PCM Loading

It will be understood that since the compacted expanded graphite is in the form of relatively thin elements after step 14, the PCM loading is made quickly in step 16.

Suitable PCM generally includes paraffin waxes that are relatively inexpensive, not prone to decomposition and which generally have a relatively low melting temperature within the recommended range of operation for Li-ion cells. Of course, other PCM can be used.

As a first non-limiting example, a continuous process for loading the PCM into the compacted expanded graphite elements is proposed. In this continuous process, the graphite elements are placed onto a conveyor, solid state PCM is placed onto the graphite elements, and the conveyor is configured to go though an oven to allow the PCM to become liquid and enter the graphite elements by capillarity.

Should the expanded graphite be compressed in continuous thin sheets, the same continuous process described hereinabove could be used, for example by placing a sheet of solid state PCM on top of the compacted graphite sheet.

Liquid state PCM could also be rolled or sprayed onto the compacted graphite elements.

As another non-limiting example, a batch process for loading the PCM into the compacted expanded graphite consists in placing the thin graphite elements into a heated vessel with solid or liquid PCM to allow the PCM to enter the graphite elements by capillarity.

Another example would be to overlay a sheet of solid state PCM onto a sheet of compacted graphite, roll this assembly into a multi-layer cylinder and place this rolled assembly into an oven so that the PCM melts and quickly enters the compacted graphite sheet.

As will be understood by one skilled in the art, the loading of the PCM within the graphite elements can be done at or under pressurized, atmospheric or vacuum conditions. Accordingly, the oven or the vessel described hereinabove may be so configured as to allow pressurization and/or allow a vacuum to be maintained therein.

Formation

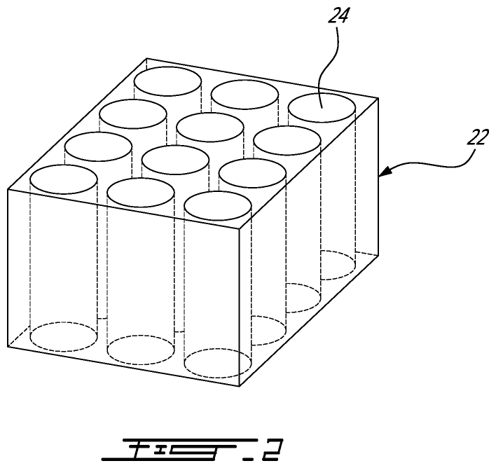

When the compacted graphite elements are loaded with PCM, they may be used to form an adequate thermal management matrix ready to receive the battery cells (step 18). One such completed thermal management matrix 22 is illustrated in FIG. 2.

If the loaded compacted graphite elements have been formed in pill form, they can be used directly to form a matrix. On the other hand, if a continuous thin sheet of loaded compacted graphite element has been formed, it may be interesting to break the continuous sheet into small pieces to facilitate the matrix-forming step.

Many techniques can be used to achieve a thermal management matrix 22 as illustrated in FIG. 2. The PCM loaded compacted graphite elements may be formed into an adequately sized block in a mold and then drilled to receive the cells. Alternatively, the cavities for the cells may be formed directly into the block via molding, injection molding or casting processing, for example. It is believed to be within the reach of a person skilled in the art to apply sufficient heat to allow the formation of the matrix from the loaded compacted graphite.

Assembly

Once the thermal management matrix 22 is completed, the assembly of the battery module may be done (step 20).

Referring to FIG. 2, it is possible to simply insert individual cells in the cavities 24 and to interconnect these cells.

However, while conventional cells are provided with an electric insulator layer, the present method includes providing a supplemental layer of an electric insulator about each of the cell elements since there is contact between the cells and the thermal management matrix and since conventional cells are not designed to support the high voltages that may be present in the matrix. Various electrical insulator materials, such as various plastics, that are well known in the art can be employed.

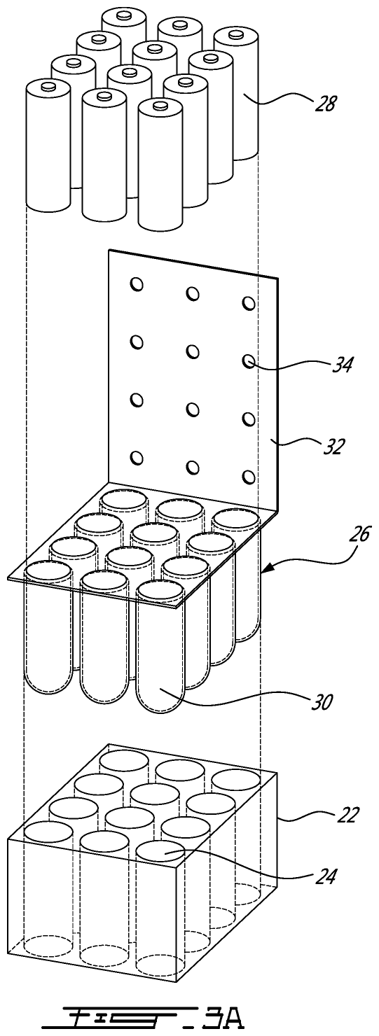

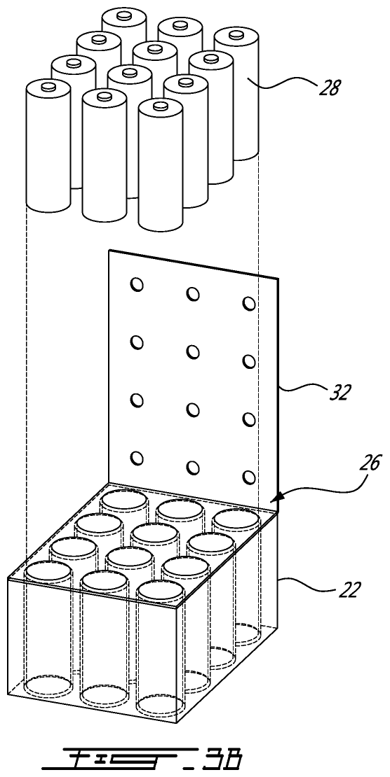

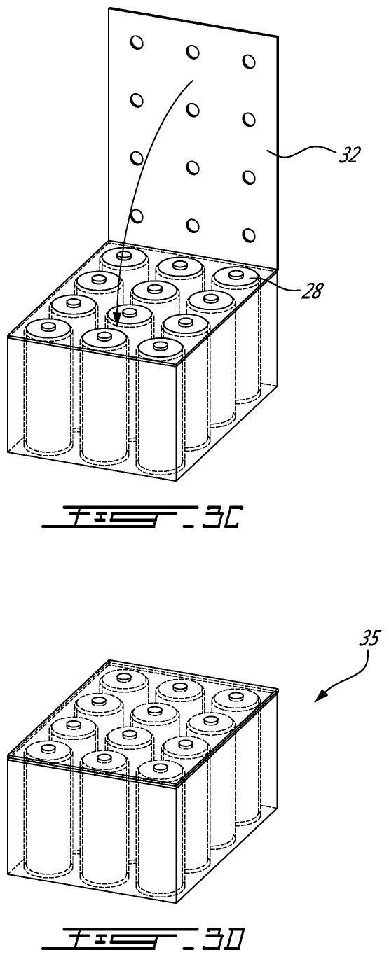

FIG. 3A illustrates an exploded view of a battery module including a thermal management matrix 22, an interconnected insulator assembly 26 made of an electrical insulating material and individual cells 28.

The interconnected insulator assembly 26 includes individual insulator sleeves 30 configured and sized so as to enter the cavities 24 of the matrix 22 relatively loosely, and so as to receive the cells 28. The sleeves 30 are interconnected so as to be inserted in the cavities at the same time. The assembly 26 also includes a foldable top layer 32 configured to cover the top of the matrix 22 when the cells are inserted therein. The top layer 32 includes apertures 34 allowing the cell tabs to be interconnected via bus bars (not shown). It is also to be noted that a bottom layer (not shown) similar to the top layer 32 is further provided to electrically insulate the bottom surface of the matrix 22 while allowing bus bars (not shown) to interconnect the cell tabs.

Of course, one skilled in the art will understand that the end of the sleeves 30 must be perforated to allow access to the bottom tabs of the cells. Alternatively, the end of the sleeves 30 could be provided with an aperture to allow access to the bottom tabs (not shown)

FIG. 3B illustrates the insulator assembly 26 inserted in the matrix 22. As mentioned hereinabove, the individual sleeves 30 are slightly smaller than the cavities 24 to facilitate insertion. However, the sleeves 30 are therefore slightly smaller than the cells 28, allowing the cells to compress the insulation material against the surface of the cavities 24 to therefore create thermal contact between the cell, the insulator and the matrix which is interesting for adequate heat transfer therebetween. It is to be noted that an adequate lubricant could be used to ease the insertion of the cells into the sleeves.

In FIG. 3C, the cells 28 have been inserted and in FIG. 3D, the top layer 32 is being closed.

The un-insulated battery module 35 is illustrated in FIG. 3D. The next step is to interconnect the tabs of the cells via bus bars (not shown) to place the cells in parallel and/or in series as required by the specific application. The battery module 35 is un-insulated since the thermal management matrix, partially made of electrically conducting expanded graphite is exposed.

Of course, one skilled in the art will understand that individual cell sleeves could be used and mounted to the cells before they are inserted in the matrix. In such a case, top and bottom layers 32 may be used to safely give access to the cell tabs.

One skilled in the art will also understand that the top and bottom layers similar to layer 32 could be provided with an adhesive layer to allow their mounting to the module 35.

Once the cells have been mounted in the thermal management matrix and bus bars (not shown) have been mounted to the tabs of the cells, the matrix and cell assembly 35 (FIG. 3D) may be electrically insulated. Indeed, since the matrix is electrically conductive, it is interesting to ensure an adequate electric insulation of the external surfaces thereof.

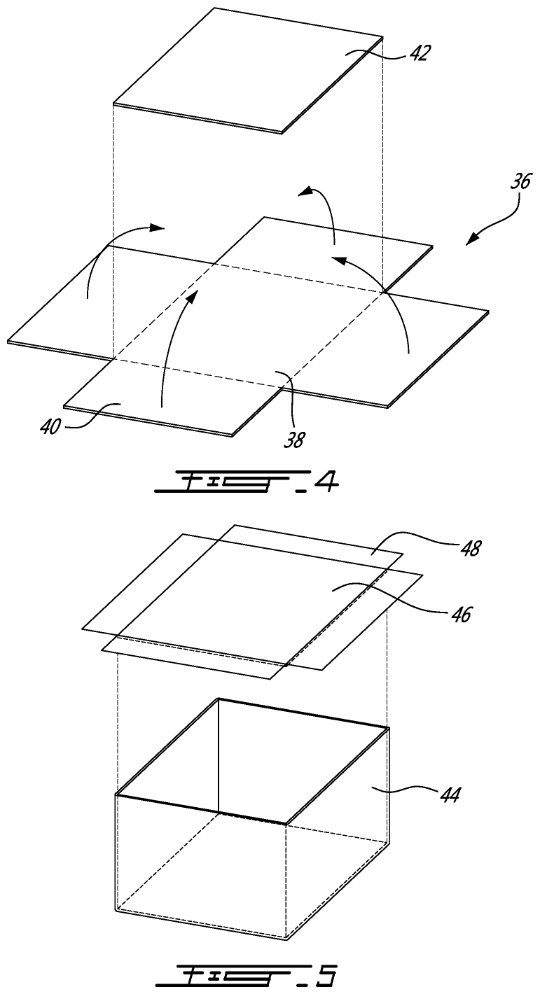

FIG. 4 illustrates a thin electrically insulating material sheet 36 that has been so cut as to facilitate the wrapping of the matrix and cell assembly 35. The wrapping material sheet 36 is for example made of plastic. Mode specifically it includes a bottom section 38, four side sections 40 and a separate top section 42. As shown by the arrows in FIG. 4, the side sections 40 may be folded to cover the sides of the matrix and cell assembly 35.

One skilled in the art will understand that the sheet 36 may include a layer of adhesive (not shown) to facilitate its assembly to the matrix and cell assembly 35.

Also, apertures (not shown) may be provided to allow the bus bars (not shown) to be accessible.

FIG. 5 illustrates an alternative electric insulation method for the matrix and cell assembly 35. A semi-rigid or rigid box 44 is made of high voltage insulating material, such as plastic, and is sized to receive the matrix and cell assembly 35. A cover 46 including flaps 48 is also provided to insulate the top side of the assembly 35.

It is to be noted that the entire cover 46, or only the flaps 48, may be provided with an adhesive layer.

Again, apertures (not shown) may be provided to allow the bus bars (not shown) to be accessible.

Those skilled in the art will understand that the size, shape, number, form or type of cell elements, or how two or more of such cell elements are joined or interconnected may be different than described herein.

One skilled in the art will also understand that some of the various features of the different elements described herein could be interchanged. As non-limiting examples, the flaps 48 of the cover 46 (see FIG. 5) could also be present on the cover 32, the sides 40 and the cover 42 to facilitate the assembly thereof.

Also, it is to be noted that some of the features of the elements described herein can be combined. As a non-limiting example, the thin electrically insulating material sheet 36 of FIG. 4 could be integral with the interconnected insulator assembly 26 of FIG. 3A.

It is to be understood that the method for making thermal management material and matrix is not limited in its application to the details of construction and parts illustrated in the accompanying drawings and described hereinabove. The method for making thermal management material and matrix is capable of other embodiments and of being practiced in various ways. It is also to be understood that the phraseology or terminology used herein is for the purpose of description and not limitation. Hence, although the method for making thermal management material and matrix has been described hereinabove by way of illustrative embodiments thereof, it can be modified, without departing from the spirit, scope and nature thereof.

What is claimed is:

1. A method of making thermal management material including:
compacting expanded graphite flakes into thin elements; and
loading the thin elements with PCM (phase change material).

2. The method of claim 1, wherein the thin elements are pill shaped.

3. The method of claim 1, wherein the thin elements are sheet shaped.

4. The method of claim 1, wherein said loading the thin elements with PCM is done in a continuous manner.

5. The method as recited in claim 1, wherein said loading the thin elements with PCM is done in a heated environment.

6. The method as recited in claim 1, said loading the thin elements with PCM is done by placing solid state PCM onto the thin elements and by placing the thin elements into a heated environment.

7. The method as recited in claim 1, wherein, during said loading the thin elements with PCM, the thin elements are continuously moving on a conveyor system.

8. The method as recited in claim 1, wherein said loading the thin elements with PCM results in PCM loaded compacted thin elements; the method further comprising breaking up the PCM loaded compacted thin elements into small pieces.

9. A method comprising:
compacting expanded graphite flakes into thin elements;
loading the thin elements with PCM, resulting in PCM loaded graphite;
breaking up the PCM loaded graphite into small pieces; and
forming a matrix from the small pieces of PCM loaded graphite.

10. The method of claim 9, wherein said loading the thin elements with PCM is done in a continuous manner.

11. The method as recited in claim 9, wherein loading the thin elements with PCM is done in a heated environment.

12. The method as recited in claim 9, wherein said loading the thin elements with PCM is done by placing solid state PCM onto the thin elements and by placing the thin elements into a heated environment.

13. The method as recited in claim 9, wherein, during said loading the thin elements with PCM, the thin elements are continuously moving on a conveyor system.

14. The method as recited in claim 9, wherein, said forming a matrix from the small pieces of PCM loaded graphite is done according to a technique selected from the group consisting of molding, injection molding or casting.

15. A method to assemble a battery module including:
providing a thermal management matrix provided with at least two cell receiving cavities and an outside surface;
inserting a respective cell into each of the at least two cell receiving cavities;
interconnecting the cells; and
electrically insulating the outside surface.

16. The method as recited in claim 15, wherein said inserting a respective cell comprises:
providing an interconnected insulator assembly made of an electrical insulating material; the interconnected insulator assembly including a separate sleeve for each of the at least two cell receiving cavities;
inserting each separate sleeve in a respective one of the at least two cell receiving cavities;
inserting each of the at least two cells into a respective sleeve.
